(19) United States
(12) Patent Application Publication
(10) Pub. No.: US 2008/0249680 A1
(43) Pub. Date: Oct. 9, 2008

(54) DATA RECORDER

(75) Inventors: Michael D. Dwyer, Seminole, FL (US); Carlos A. Ibarra, Clearwater, FL (US); John W. Thornberry, Largo, FL (US)

Correspondence Address: HONEYWELL INTERNATIONAL INC.;PATENT SERVICES AB-2B, 101 COLUMBIA ROAD, P.O. BOX 2245, MORRISTOWN, NJ, 07962-2245, US

(73) Assignee: HONEYWELL INTERNATIONAL INC., Morristown, NJ (US)

(21) Appl. No.: 11/696,453

(22) Filed: Apr. 4, 2007

(51) Int. Cl. G07C 5/08

(52) U.S. Cl. 701/35; 369/21

(57) ABSTRACT

Systems and methods for recording information in a vehicle data recorder device. The vehicle data recorder device includes an inertial measurement unit (IMU), a crash survivable unit having memory, and a microcontroller in data communication with the IMU and the memory. The microcontroller receives angular rate information and acceleration information from the IMU and stores the received angular rate information and acceleration information in the memory. The IMU includes two or more MEMS gyroscopes or ring laser gyroscopes. In one example, the microcontroller stores angular rate information and acceleration information in the memory until a threshold event has occurred. The threshold event includes at least one of the angular rate information or acceleration information indicating zero with respect to a rotating earth coordinate frame for a predetermined period of time.

### BACKGROUND OF THE INVENTION

Data recorders, such as flight data and voice data recorders, when used in aircraft record flight profile information and flap, gear and other control settings. A record of data is made for a predefined period of time, e.g. 30 minutes. If a crash occurs, the data that is recorded is used to assist the determining the cause of the crash.

Modern data recorders or “black boxes” only record data that is sent to it from other aircraft systems and do not generate any recordable information themselves. There have been several instances where the flight instruments went completely dark in an all electronic passenger jet due to associated computer failure. In this case, the data recorder did not store any information for the period of time that the computer was not functioning.

Therefore, there exists a need for recording of flight data during times of electronic flight instrument failure.

### SUMMARY OF THE INVENTION

The present invention provides systems and methods for recording information in a vehicle data recorder device. The vehicle data recorder device includes an inertial measurement unit (IMU), a crash survivable unit having memory, and a microcontroller in data communication with the IMU and the memory. The microcontroller receives angular rate information and acceleration information from the IMU and stores the received angular rate information and acceleration information in the memory.

In one aspect of the invention, the IMU includes two or more MEMS gyroscopes and three MEMS accelerometers.

In another aspect of the invention, the IMU includes two or more ring laser gyroscopes.

In still another aspect of the invention, the microcontroller stores angular rate information and acceleration information in the memory until a threshold event has occurred. The threshold event includes at least one of the angular rate information or acceleration information indicating zero with respect to a rotating earth coordinate frame for a predetermined period of time.

### BRIEF DESCRIPTION OF THE DRAWINGS

Preferred and alternative embodiments of the present invention are described in detail below with reference to the following drawings:

FIG. 1 illustrates a schematic block diagram of an example data recorder formed in accordance with an embodiment of the present invention.

### DETAILED DESCRIPTION OF THE PREFERRED EMBODIMENT

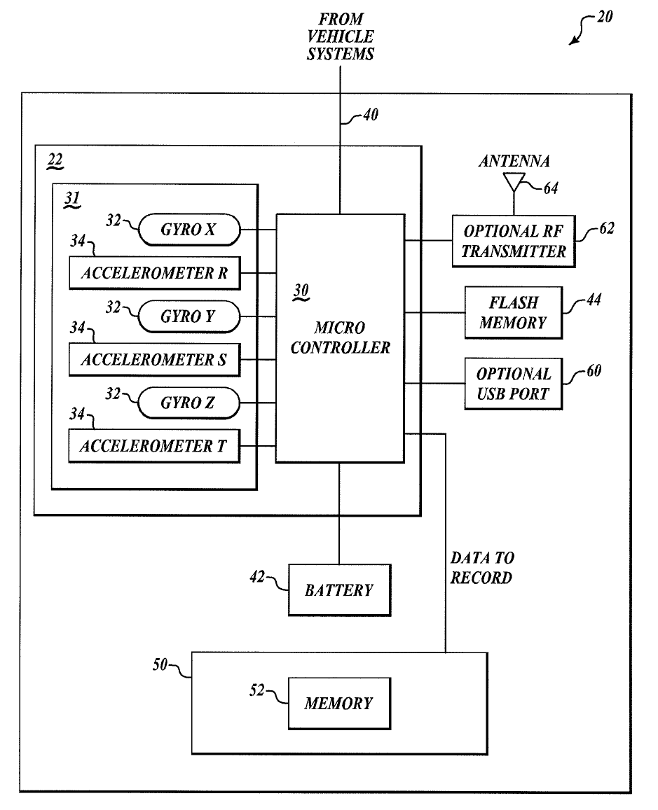

FIG. 1 illustrates a block diagram of an example data recorder 20 formed in accordance with an embodiment of the present invention. The data recorder 20 includes a processing section 22 that includes a microcontroller 30, an Inertial Measurement Unit (IMU) 31, an optional battery 42, and a connection 40 for receiving data from various aircraft components and for receiving power. The IMU 31 includes three gyros (X, Y, Z) 32 and three accelerometers (R, S, T) 34. The recorder 20 also includes a crash survivable component 50 that includes memory 52 that is in data communication with the microcontroller 30.

The microcontroller 30 receives flight profile information and flap, gear, and other control setting information from external sources via the connection 40. The microcontroller 30 also receives rate information from the three gyros 32 and accelerometer information (acceleration) from the three accelerometers 34. The microcontroller 30 processes all the received data according to a predefined protocol and sends the processed information to the memory 52.

In an alternate embodiment, the recorder 20 may include a radio frequency (RF) transmitter/receiver 62 that is in signal communication with the microcontroller 30 and an antenna 64. The transceiver 62 may be implemented for wirelessly transmitting data stored in the memory 52 to a remote system. The recorder 20 may also include a USB port 60 and/or a flash memory component 44 that is also in data communication with the microcontroller 30. The USB port 60 is connectable to testing equipment or a computer device for downloading data stored in the memory 52 or analyzing operation of the recorder 20. The flash memory component 44 may include removable flash memory that can be analyzed by a remote computer system.

In one embodiment, the gyros 32 and accelerometers 34 are micro-electromechanical systems (MEMS) devices, such as the HG1900 Gyro and RB500 Accelerometers produced by Honeywell, Inc.® Also, a combined gyroscope accelerometer system, such as HG1700 may be used. In another embodiment, the gyros are replaced by ring laser gyros (RLG) or comparable angular rate measurement devices. Also, the accelerometers may be replaced by comparable acceleration measurement devices.

In one embodiment, the gyros 32 and accelerometers 34 operate at a frequency of approximately 100 Hz. Because angular rate or acceleration readings are performed for each of the gyros 32 and accelerometers 34, then approximately 600 records per second are produced (36,000 records per minute). Therefore, in this embodiment, provided enough memory exists in the memory 52, thirty minutes of acceleration and angular rate information is stored.

In another embodiment, if the battery 42 is included, the microcontroller 30 may be preprogrammed to continue to store data received from the gyros 32 and accelerometers 34 for a predefined period of time after a catastrophic incident has occurred. For example, the microcontroller 30 stops recording information from the gyros 32 and accelerometers 34, if the angular rate and acceleration values recorded go to zero and stay at zero for a preset period of time. In other words, the microcontroller 30 determines that the recorder 20 is in a steady state or no motion state situation with respect to a rotating earth coordinate frame.

In one embodiment, the IMU 31 includes only X, Y Gyros and the R, S, T Accelerometers and no battery is included. That is no Z Gyro is included. This provides a lower cost version of the system shown in FIG. 1.

While the preferred embodiment of the invention has been illustrated and described, as noted above, many changes can be made without departing from the spirit and scope of the invention. Accordingly, the scope of the invention is not limited by the disclosure of the preferred embodiment. Instead, the invention should be determined entirely by reference to the claims that follow.

1. A vehicle data recorder device comprising:
an inertial measurement unit (IMU);
a crash survivable unit comprising memory; and
a microcontroller in data communication with the IMU and the memory.

2. The device of claim 1, wherein the microcontroller receives angular rate information and acceleration information from the IMU and stores the received angular rate information and acceleration information in the memory.

3. The device of claim 2, wherein the IMU comprises two or more MEMS gyroscopes.

4. The device of claim 3, wherein the IMU comprises three MEMS accelerometers.

5. The device of claim 2, wherein the IMU comprises two or more ring laser gyroscopes.

6. The device of claim 1, further comprising a battery connected to the microcontroller.

7. The device of claim 1, wherein the microcontroller includes a communication component.

8. The device of claim 1, wherein the microcontroller is configured to store measurement information related to angular rate and acceleration in the memory until a threshold measurement event has occurred.

9. The device of claim 8, wherein the threshold measurement event includes at least one of the angular rate information or acceleration information indicating zero with respect to a rotating earth coordinate frame for a predetermined period of time.

10. A method for recording data in a vehicle data recorder, the method comprising:
measuring angular rate information and acceleration information from an inertial measurement unit (IMU) located within the data recorder; and
storing the measured angular rate information and acceleration information in memory located in a crash survivable unit located within the data recorder.

11. The method of claim 10, wherein the IMU comprises two or more MEMS gyroscopes.

12. The method of claim 11, wherein the IMU comprises three MEMS accelerometers.

13. The method of claim 10, wherein the IMU comprises two or more ring laser gyroscopes.

14. The method of claim 10, further comprising powering components of the data recorder using a battery located within the data recorder.

15. The method of claim 10, wherein storing comprises storing measurement information related to angular rate and acceleration in the memory until a threshold measurement event has occurred.

16. The method of claim 15, wherein the threshold measurement event includes at least one of the angular rate information or acceleration information indicating zero with respect to a rotating earth coordinate frame for a predetermined period of time.
